(19) United States
(12) Patent Application Publication
(10) Pub. No.: US 2009/0003568 A1
(43) Pub. Date: Jan. 1, 2009

(54) System and method to enhance telephone call awareness

(75) Inventor: Victor Koretsky, Ra'anana (IL)

Correspondence Address: GIBBONS P.C., ONE GATEWAY CENTER, NEWARK, NJ, 07102, US

(73) Assignee: DSP Group Limited

(21) Appl. No.: 11/821,849

(22) Filed: Jun. 26, 2007

(51) Int. Cl. H04M 1/56

(52) U.S. Cl. 379/142.01

(57) ABSTRACT

A system for enhancing telephone call awareness, including, a call awareness device with a connection to an incoming telephone line and optionally a connection to the Internet. The call awareness device is adapted to record details from incoming calls and provide the details in one or more forms to one or more recipients over the connections available on the call awareness device.

### FIELD OF THE INVENTION

The present invention relates generally to providing notification regarding telephone calls arriving during a person's absence.

### BACKGROUND OF THE INVENTION

On many occasions a person is away from his/her house or office and cannot answer telephone calls that arrive there. The person could install an answering machine and then receive messages when he/she returns. However if the person is gone for an extended period of time the memory of the answering machine may not suffice and additionally, the person does not receive notification if a message is important and requires immediate action. Some answering machines allow the person to call in and collect their messages; however this requires the person to periodically call the answering machine to find out if any messages arrived. Additionally, the person may be in a foreign country where it is unfeasible or complicated to contact their answering machine by telephone.

Many callers don't leave messages, so the answering machine does not help to determine if calls were missed. Some telephone companies offer a service, which provides the caller identification (e.g. caller telephone number) without even answering the call. A person can install a device that will record the caller IDs and the person can view a list of caller IDs when he/she arrives. However, as with the answering machine the person is not notified when calls arrive. If a person is waiting for a specific call, the person has no way of knowing that they called immediately after the call.

### SUMMARY OF THE INVENTION

An aspect of an embodiment of the invention, relates to a system and method of enhancing telephone call awareness by connecting a call awareness device to the telephone line, which is to be monitored. Additionally, the call awareness device is connected to an Internet connection. In an exemplary embodiment of the invention, when the telephone owner is away the call awareness device answers the telephone, records messages, records faxes and any other type of transmission. Optionally, the call awareness device provides notification to one or more recipients that a telephone call has arrived, for example the call awareness device sends an SMS or email to the owner relating the identity of the caller. Optionally, the call awareness device may call the owner at his/her current location and relate the recorded message using the telephone line by which the call was received. In an exemplary embodiment of the invention, the call awareness device may record the identity of the caller without answering the call, and send the information to the owner. In some embodiments of the invention, the call awareness device may send notification regarding the identity of the caller even if somebody answers the call.

In an exemplary embodiment of the invention, the notification may be by immediate message over the Internet, by email, by SMS, by MMS, by fax or by any other method. Optionally, the system may provide servers which assist in forwarding the notification to the recipients by various methods.

In an exemplary embodiment of the invention, the call awareness device can be programmed to define various rules regarding the handling of incoming calls and the sending notification, for example to define how to send notification, what to send as a notification, to whom to send notification, when to send notification.

In some embodiments of the invention, the system monitors the notifications sent by the call awareness device and bills the owner for use of the device.

There is thus provided according to an exemplary embodiment of the invention, a system for enhancing telephone call awareness, including:
a call awareness device with a connection to an incoming telephone line;

wherein the call awareness device is adapted to record details from incoming calls and automatically provide the details in one or mote forms to one or more recipients over the connection available to the call awareness device.

Optionally, the system further comprises a connection to the Internet; and wherein the call awareness device is adapted to automatically provide the details over the telephone line, the Internet connection or both. In an exemplary embodiment of the invention, the system further comprises a server that receives fax messages from the call awareness device and transmits them to one or more recipients. Optionally, the system further comprises a server that receives messages from said call awareness device and emails them to one or more recipients. In an exemplary embodiment of the invention, the system further comprises a server that receives voice messages from the call awareness device and calls recipients and plays the voice message to them. Optionally, the system further comprises a server that receives messages from the call awareness device and sends them as short message service (SMS) messages to one or more recipients. In an exemplary embodiment of the invention, the system further comprises a server that receives messages from the call awareness device and sends them as multimedia messaging service (MMS) messages to one or more recipients. Optionally, the call awareness device is adapted to record caller identity (ID) and notify the one or more recipients with the identity of the callers. In an exemplary embodiment of the invention, the call awareness device is adapted to identify the caller's identity (ID) and selectively notify one or more recipients responsive to the identity of the caller. Optionally, the call awareness device is adapted to identify the caller's identity (ID) and provide different types of notifications responsive to the identity of the caller.

In an exemplary embodiment of the invention, the call awareness device is user programmable. Optionally, the call awareness device is programmed to provide notification regarding receipt of a call with a time delay. In an exemplary embodiment of the invention, the call awareness device is programmed to provide notification regarding receipt of calls at a specific time of day. Optionally, the system keeps track of the notifications sent by the call awareness device and bills the user accordingly. In an exemplary embodiment of the invention, the call awareness device records the caller identity and does not answer the call. Optionally, the call awareness device is programmed to answer calls after a pre-selected number of rings. In an exemplary embodiment of the invention, the call awareness device is programmed to provide a voice response and record the caller's message. Optionally, the call awareness device is programmed to record all sounds made by the caller. In an exemplary embodiment of the invention, the details of the incoming calls include caller identity and time and date of the call. Optionally, the forms include a text message, an audio message, a fax message, an immediate message, an SMS message, and an MMS message.

There is thus further provided according to an exemplary embodiment of the invention, a method of enhancing telephone call awareness, including:

connecting a call awareness device to a telephone line;

monitoring incoming calls on the telephone line;

recording details from the incoming calls;

preparing notification for one or more recipients regarding the recorded details using the connection available for the call awareness device.

Optionally, the method further includes:

connecting said call awareness device to an Internet connection in addition to the connection with the telephone line; and

providing notification over the telephone line, the Internet connection or both.

### BRIEF DESCRIPTION OF THE DRAWINGS

The present invention will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of a calling awareness system, according to an exemplary embodiment of the invention;

FIG. 2 is a flow diagram of a method of updating a person regarding the arrival of telephone calls, according to an exemplary embodiment of the invention; and

FIG. 3 is a schematic illustration of the display of an application for handling calls, according to an exemplary embodiment of the invention.

### DETAILED DESCRIPTION

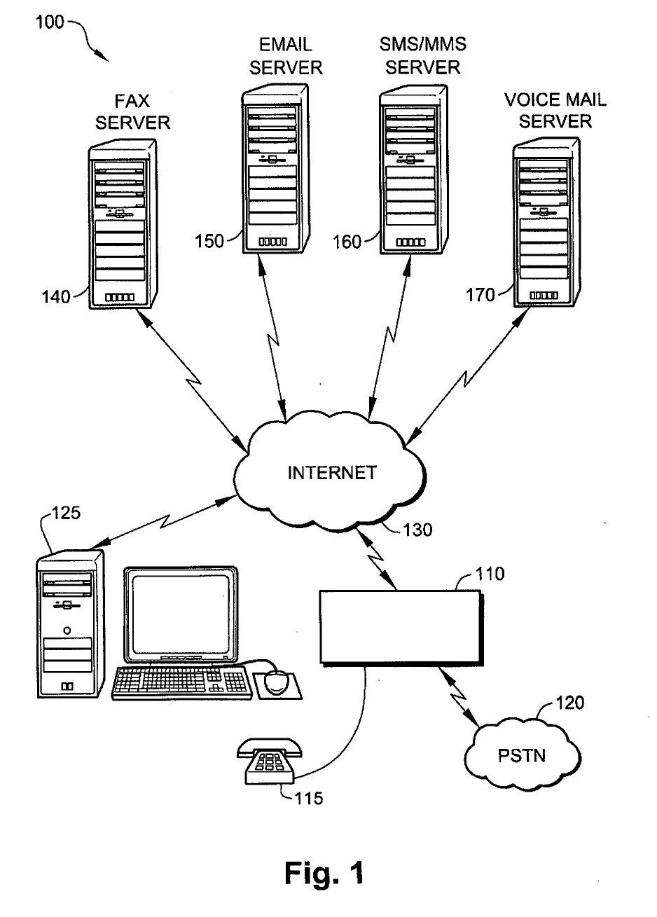

FIG. 1 is a schematic illustration of a calling awareness system 100, according to an exemplary embodiment of the invention. In an exemplary embodiment of the invention, a call awareness device 110 is connected between a person's telephone line and a person's telephone 115 so that the person may answer calls when he/she is there. Alternatively, call awareness device 110 may be connected in parallel to the person's telephone 115, for example by using a splitter on the telephone outlet or by using a parallel outlet. In an exemplary embodiment of the invention, call awareness system 110 processes incoming calls and provides the person with details of the call in other forms and on other types of devices as described below.

In some embodiments of the invention, call awareness device 110 is a general purpose computer with a modem installed to interface with standard telephone lines. Optionally, the computer intercepts calls after a specific number of rings thus giving the person a chance to answer the call first if he/she is at the location. Alternatively, call awareness device 110 is a dedicated device for handling phone calls, for example an enhanced telephone. Optionally, a remote computer 125 may be used to program call awareness device 110, for example by communicating with it over the Internet or dialing to call awareness device 110 and conducting a data session with the device.

In an exemplary embodiment of the invention, call awareness device 110 is connected to standard telephone lines, which are connected, via a public switched telephone network (PSTN) 120. Alternatively or additionally, call awareness device 110 may function with other types of telephone connections, for example cable telephone and IP telephones. In an exemplary embodiment of the invention, call awareness device 110 is connected to the Internet 130 in addition to whatever telephone system or systems it is connected to, so that it may provide some functions over the Internet.

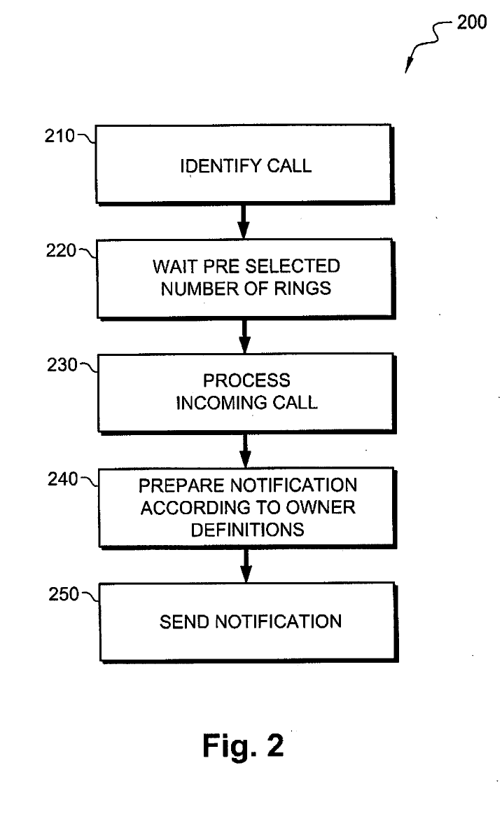

FIG. 2 is a flow diagram of a method 200 of updating a person regarding the arrival of telephone calls, according to an exemplary embodiment of the invention. In an exemplary embodiment of the invention, call awareness device 110 identifies (210) an incoming call, for example from the ring signal on the telephone line. Optionally, call awareness device 110 waits (220) a pre-selected number of rings to allow the person to answer the call. After waiting the pre-selected number of rings, if the person did not answer, call awareness device 110 processes (230) the incoming call. Optionally, processing the incoming call includes one or more of the following acts or other acts:

1. Recording the caller ID without answering the call.

2. Recording the caller ID and answering the call.

3. Sounding a recorded message and accepting a message from the caller.

4. Recording all sounds made by the caller.

5. Providing correct handshaking to accept fax messages and data transmissions and record the content for later use.

6. Process the user message with a voice recognition system and convert the message into text form.

In an exemplary embodiment of the invention, once the desired details of the call are recorded; call awareness device 110 prepares (240) a notification to be sent to the person to make him/her aware of the incoming call. In an exemplary embodiment of the invention, call awareness device 110 may or may not allow the person to define details such as how to send notification, whom to notify, what to send as notification, and when to send notification. Optionally, call awareness device 110 then sends (250) notification according to the defined details as explained below.

In an exemplary embodiment of the invention, the notification may be sent to the person's mobile telephone as an SMS message or an MMS message. Optionally, call awareness device 110 uses the telephone line, the Internet connection or any other type of communication interface it has (e.g. cable telephone) to deliver the message, for example call awareness device 110 may use the standard telephone line to send an SMS or FAX. Alternatively or additionally, call awareness device 110 may send an SMS/MMS message to an SMS/MMS server 160, that is provided as part of system 100 and accessible over the Internet to send the notification. In some embodiments of the invention, call awareness device 110 may use a fax server 140 that is provided as part of system 100 (e.g. over the internet) to send notification to a selected fax number. In some embodiments of the invention, call awareness device 110 may use an email server 150 that is provided as part of system 100 (e.g. over the Internet) to send notification to an email address, so that the person will receive notification for every call by email. Optionally, call awareness device 110 may provide an audio file (e.g. in wav or mp3 format) with the message, and email server 150 will add the audio file as an attachment to the email message sent to the person.

In some embodiments of the invention, call awareness device 110 may send a voice message to the person, for example by calling their mobile telephone or by sending a file with the voice message attached to a voice mail server 170, which is provided as part of system 100. Optionally, voice mail server 170 is adapted to receive voice files over the Internet and provide them to a person by calling a telephone number that is provided with the message. In an exemplary embodiment of the invention, call awareness device 110 may send an immediate message using an immediate message service, for example ICQ, MSN or other immediate message services. In some embodiments of the invention, a single server may provide the functions of servers 140, 150, 160, and 170 as described above. Alternatively, multiple servers may provide the function for each server, for example multiple fax servers or multiple email servers. In some embodiments of the invention, one or more of the servers of system 100 may track usage of the various services provided to call awareness device 110 and bill the person for providing these services.

In an exemplary embodiment of the invention, the notification may be sent to a single person or to a group of people. Optionally, the recipients may be selected based on the identity of the caller, for example a call from a specific caller ID may cause call awareness device 110 to notify a group of people whereas a different caller ID may cause call awareness device 110 to give notification to a single person.

In an exemplary embodiment of the invention, calling awareness device 110 may simply notify that a call has been received. Alternatively or additionally, call awareness device 110 may provide as notification details of the call, for example—the caller ID, an audio message recorded from the content of the call, a fax message or a text message created from the recorded audio message using a voice recognition system or in any other form.

In some embodiments of the invention, the user can define a time for sending notifications regarding the calls that arrived, for example immediately, with a pre-selected delay or to send all the messages at a specific time each day.

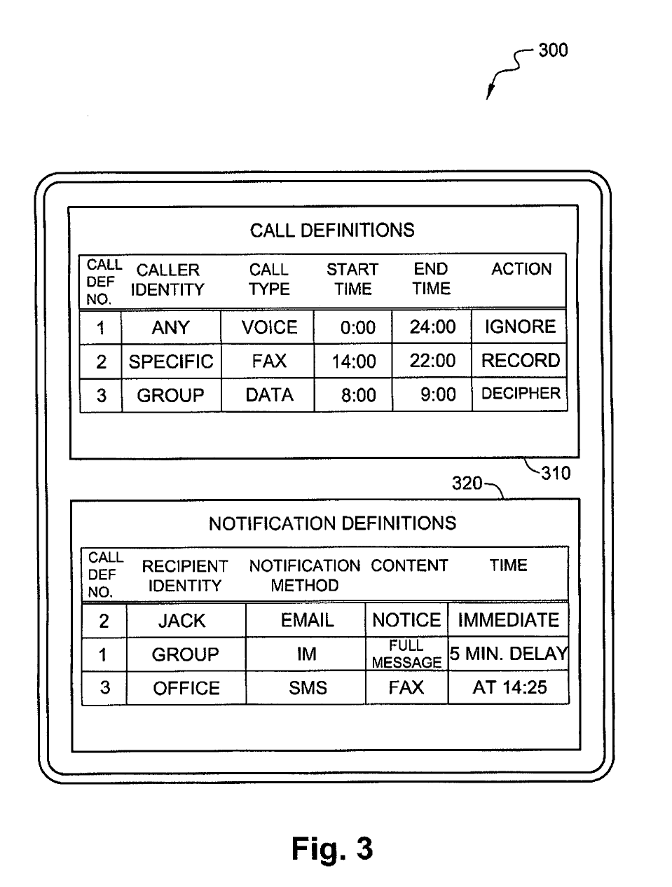

FIG. 3 is a schematic illustration of the display of an application 300 for handling calls, according to an exemplary embodiment of the invention. In an exemplary embodiment of the invention, the person that installs call awareness device 110 can program the defined details described above by accessing application 300. Optionally, application 300 can be used to define simple rules or complex rules, which will be implemented to handle incoming calls. In an exemplary embodiment of the invention, application 300 includes a call definition display 310 and a notification definition display 320. Optionally, call definition display 310 includes details regarding the reception of calls by call awareness device 110 and how they will be handled, for example:

1. Call definition no.—defining a number for the call rule to define later which notification definition to use to handle the call accepted by the call rule.

2. Caller identity—the caller identity defines, which callers will be handled by the specific rule, for example all callers, callers with unidentified IDs, callers from IDs belonging to a group, or calls from specific IDs.

3. Call type—the type of call defines the type of content that will have the ruled applied to it, for example if the message is a voice message, a fax message or a data transmission.

4. Start time and end time—to define a time range during which to apply the rule, for example if the call occurs after a certain time (e.g. office hours) it can be defined to be ignored.

5. Action—to define an action to be taken for a call matching the above definitions, for example:

a. If a specific user or user from a specific group of users calls don't answer the call just record the time and date and ID.

b. If a specific user calls between 08:00-10:00 record a message.

c. If any user calls with a fax message at any time, record the fax message.

d. If a specific user calls at any time decipher the audio message and convert it into text.

In an exemplary embodiment of the invention, notification definition display 320 includes definitions regarding handling the calls that were received and sending out notifications to people about the calls, for example:

1. Call definition number—to match between the call definitions and the notification definitions by defining, which call definition will be handled by the specific notification definition.

2. recipient identity—the recipient identity defines the person or group of people that will receive the notification.

3. Notification method—the notification method will used to deliver the message to those defined by the recipient identity, for example sending an email, sending an immediate message, sending an SMS/MMS, sending a voice message or sending a fax message.

4. Notification content—defines the content that will be delivered, for example a notice that a call was received at a specific time and date, an audio file with the recorded message, the fax message.

5. Delivery time—the time for delivery of the message, for example with a constant delay (e.g. +5 minutes), at a specific time (e.g. at 14:25), or immediately.

Optionally, according to the above definitions a person may control the forwarding of messages arriving at his/her telephone, for example:

1. To have messages from specific callers reported to him/her immediately by SMS or email.

2. To have messages from specific callers recorded and played back on the persons mobile telephone.

3. To have faxes forwarded to another fax machine.

4. To have messages from calls during the day give immediate notification, whereas messages from after work hours give notification only the next morning at a specific time.

In some embodiments of the invention, other parameters may be entered by the user to allow more complex variations for handling calls.

In some embodiments of the invention, call awareness device 110 may be used to provide notification regarding calls on a telephone line even if they are answered by a user, for example to send an SMS or email with the caller ID for every incoming call.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

It will be appreciated by persons skilled in the art that the present invention is not limited to what has been particularly shown and described hereinabove. Rather the scope of the present invention is defined only by the claims, which follow.

1. A system for enhancing telephone call awareness, comprising:
a call awareness device with a connection to an incoming telephone line; wherein said call awareness device is adapted to record details from incoming calls and automatically provide the details in one or more forms to one or more recipients over the connection available to the call awareness device.

2. A system according to claim 1, further comprising a connection to the Internet; and wherein said call awareness device is adapted to automatically provide the details over the telephone line, the Internet connection or both.

3. A system according to claim 2, further comprising a server that receives fax messages from said call awareness device and transmits them to one or more recipients.

4. A system according to claim 2, further comprising a server that receives messages from said call awareness device and emails them to one or more recipients.

5. A system according to claim 2, further comprising a server that receives voice messages from said call awareness device and calls recipients and plays the voice message to them.

6. A system according to claim 1, further comprising a server that receives messages from said call awareness device and sends them as short message service (SMS) messages to one or more recipients.

7. A system according to claim 1, further comprising a server that receives messages from said call awareness device and sends them a multimedia messaging service (MMS) messages to one or more recipients.

8. A system according to claim 2, wherein said call awareness device is adapted to record caller identity (ID) and notify said one or more recipients with the identity of the callers.

9. A system according to claim 2, wherein said call awareness device is adapted to identify the caller's identity (ID) and selectively notify one or more recipients responsive to the identity of the caller.

10. A system according to claim 2, wherein said call awareness device is adapted to identify the caller's identity (ID) and provide different types of notifications responsive to the identity of the caller.

11. A system according to claim 2, wherein said call awareness device is user programmable.

12. A system according to claim 2, wherein said call awareness device is programmed to provide notification regarding receipt of a call with a time delay.

13. A system according to claim 2, wherein said call awareness device is programmed to provide notification regarding receipt of calls at a specific time of day.

14. A system according to claim 2, wherein said system keeps track of the notifications sent by said call awareness device and bills the user accordingly.

15. A system according to claim 2, wherein said call awareness device records the caller identity and does not answer the call.

16. A system according to claim 2, wherein said call awareness device is programmed to answer calls after a pre-selected number of rings.

17. A system according to claim 2, wherein said call awareness device is programmed to provide a voice response and record the caller's message.

18. A system according to claim 2, wherein said call awareness device is programmed to record all sounds made by the caller.

19. A system according to claim 2, wherein said details of the incoming calls include caller identity and time and date of the call.

20. A system according to claim 2, wherein said forms include a text message, an audio message, a fax message, an immediate message, an SMS message, and an MMS message.

21. A method of enhancing telephone call awareness, comprising:
connecting a call awareness device to a telephone line;
monitoring incoming calls on the telephone line;
recording details from the incoming calls;
preparing notification for one or more recipients regarding the recorded details using the connection available for the call awareness device.

22. A method according to claim 2, further comprising:
connecting said call awareness device to an Internet connection in addition to the connection with the telephone line; and
providing notification over the telephone line, the Internet connection or both.

23. A system according to claim 2, further comprising a server that receives messages from said call awareness device and sends them as short message service (SMS) messages to one or more recipients.

24. A system according to claim 2, further comprising a server that receives messages from said call awareness device and sends them a multimedia messaging service (MMS) messages to one or more recipients.
